(19) United States
(12) Patent Application Publication
(10) Pub. No.: US 2026/0059486 A1
(43) Pub. Date: Feb. 26, 2026

(54) LOCATION-BASED NEIGHBOR CELL MEASUREMENT DISABLEMENT

(71) Applicant: Charter Communications Operating, LLC, St. Louis, MO (US)

(72) Inventor: Saran Khalid, Denver, CO (US)

(21) Appl. No.: 18/814,080

(22) Filed: Aug. 23, 2024

(51) Int. Cl. H04W 64/00; H04W 36/00; H04W 36/30; H04W 36/32

(52) U.S. Cl. CPC H04W 64/003; H04W 36/0088; H04W 36/302; H04W 36/324

(57) ABSTRACT

A user equipment (UE) is provided. The UE operates on a wireless communication network and is served by a serving base station. The wireless communication network includes a plurality of neighbor base stations that are adjacent to the serving base station. The UE obtains location data associated with the UE and, based on the location data, disables neighbor cell measurements for at least one neighbor base station. The neighbor cell measurements characterize a communication link between the UE and the at least one neighbor base station. The UE may disable the neighbor cell measurements for some, or all, of the neighbor base stations.

### BACKGROUND

A wireless service provider typically installs a network of base stations in a relatively large geographic area to provide wireless communication network coverage to customers (e.g., users). Typically, there will be a coverage area overlap between base stations in relatively close proximity to one another. To access the wireless communication network, customer devices (e.g., user equipment (UE(s))) establish a communication link with a serving base station, which is typically the base station having the strongest and most reliable signal. Customer devices also identify and monitor other base stations that are adjacent to the serving base station (e.g., neighbor base stations) in order to, inter alia, facilitate handoff transactions that may be needed.

### SUMMARY

The examples disclosed herein intelligently control a neighbor cell measurement mode (e.g., normal operation, reduced neighbor cell measurements, no neighbor cell measurements) of a user equipment (UE) (e.g., mobile phone, tablet, etc.) based on location data associated with the UE.

In one implementation, a method is provided. The method includes obtaining, by a user equipment (UE) served by a serving base station of a wireless communication network, location data associated with the UE, the wireless communication network comprising a plurality of neighbor base stations adjacent to the serving base station. The method further includes disabling, by the UE based on the location data, neighbor cell measurements for at least one neighbor base station of the plurality of neighbor base stations, the neighbor cell measurements characterizing a signal strength of a communication link between the UE and the at least one neighbor base station.

In another implementation, a user equipment (UE) is provided. The UE includes a radio frequency (RF) device operable to establish a communication link with a serving base station. The UE further includes a memory. The UE further includes a processor device coupled to the memory. The processor device is operable to obtain location data associated with the UE. The processor device is further operable to, based on the location data, disable neighbor cell measurements for at least one neighbor base station of a plurality of neighbor base stations, the neighbor cell measurements characterizing a signal strength of a communication link between the UE and the at least one neighbor base station.

In another implementation, a non-transitory computer-readable medium. The non-transitory computer-readable medium includes executable instructions configured to cause a processor device to obtain location data associated with a user equipment (UE), the UE being served by a serving base station of a wireless communication network. The executable instructions are further configured to cause the processor device to disable, for the UE, neighbor cell measurements for at least one neighbor base station of a plurality of neighbor base stations, the neighbor cell measurements characterizing a signal strength of a communication link between the UE and the at least one neighbor base station.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for intelligently controlling a neighbor cell measurement mode of a user equipment (UE) according to some implementations;

FIGS. 2A-2C are illustrative examples of neighbor cell measurement operations according to some implementations;

FIGS. 3A-3B are a sequence diagram illustrating messages communicated between and actions taken by certain components illustrated in FIG. 1 to intelligently disable neighbor cell measurements according to some implementations;

FIG. 4 is a flowchart of a method for intelligently disabling neighbor cell measurements according to one implementation;

FIGS. 5A-5B are sequence diagrams illustrating messages communicated between and actions taken by certain components illustrated in FIG. 1 to intelligently disable neighbor cell measurements according to some implementations;

FIG. 6 is a flowchart of a method for intelligently disabling neighbor cell measurements according to one implementation; and

FIG. 7 is a block diagram of a user equipment (UE) suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A wireless service provider typically installs a network of base stations in a relatively large geographic area to provide wireless communication network coverage to customers (e.g., users). Typically, there will be a coverage area overlap between base stations in relatively close proximity to one another. Customer devices (hereinafter “user equipment” or “UE”), such as mobile phones, mobile tablet devices, and/or the like, interact with the network of base stations to establish and maintain a connection (e.g., communication link) to the wireless communication network.

As one example, a UE may first perform a “cell selection” process in which the UE scans an area to identify the various base stations that are available for connection. The UE may then obtain and store various network/connection metrics (e.g., signal strength (Srxlev), signal quality (Squal), etc.) for each detected base station. The base station having the strongest and/or most reliable signal (e.g., as indicated by the various network/connection metrics) may be selected (by the UE) as the “serving base station,” and the other detected base stations that are not selected as the “serving base station” may be identified (by the UE) as the “neighbor base station(s).”

As used herein, the term “base station” refers to a system that includes an antenna, or multiple antenna, and one or more computing devices, at least one of which is coupled to the antenna and capable of transmitting and receiving signals via the antenna. The antenna may be integrated into a same frame or housing as the computing device or may be standalone and communicatively coupled to the computing device via a communications medium, such as a fiber or wired communications medium. The base station may comprise a cellular base station such as a 4G, 5G or other type of cellular base station. Alternatively, the base station may comprise a mesh network base station. Furthermore, as used herein, the term “coverage area” refers to the geographic area within which a device, such as a UE, may be serviced by a base station. The term “coverage area” and the term “cell” may be used interchangeably herein. Even further, a “serving base station” refers to the base station that operates as the primary point of communication between the UE and the wireless communication network; the other detected base stations that are adjacent to the serving base station are referred to herein as “neighbor base station(s).”

After establishing a communication link with the serving base station, the UE typically (continuously) monitors the signal strength and the signal quality from the serving base station. Additionally, the UE typically (continuously) monitors the signal strengths and signal quality from each neighbor base station, which is a process commonly referred to as “neighbor cell measurement(s).” Neighbor cell measurements enable the UE to maintain an optimal connection (e.g., best possible signal strength, best possible signal quality) as it moves throughout the wireless communication network (e.g., between different coverage areas within the wireless communication network). For instance, neighbor cell measurements play a crucial role in handoff and/or handover (hereinafter “handoff”) transactions by continuously monitoring nearby base stations that are proximate to the serving base station.

As used herein, a “handoff” and/or a “handoff transaction” refers to a process whereby a communication link between a UE and a wireless communication network is transferred from one base station to another (e.g., different) base station without interruption. Handoff transactions are essential to maintaining optimal connectivity as users move between different coverage areas within wireless communication networks.

As an illustrative example, a first base station may have a coverage area that envelops a user’s home, and a second base station may have a coverage area that envelops the user’s workplace. Thus, the first base station will be the serving base station for the user’s UE while the user is at home, and the second base station will be the serving base station for the user’s UE while the user is at their workplace.

In this illustrative example, suppose the coverage area of the first base station is adjacent to the coverage area of the second base station. At some point during the user’s commute from their home to their workplace, the UE (or the wireless service provider) must initiate a handoff transaction to transfer the UE from the first base station to the second base station. By continuously performing neighbor cell measurements, the UE will detect a decrease in the signal strength and signal quality provided by the first (e.g., serving) base station during the user’s commute from their home to their workplace. Likewise, the UE will also detect an increase in the signal strength and signal quality provided by the second (e.g., neighbor) base station during the user’s commute. In this manner, the user’s UE (and/or the wireless service provider) is able to identify the second base station and, at some point during the user’s commute, transfer its connectivity from the first base station to the second base station, thereby ensuring the communication link between the UE and the wireless communication network remains uninterrupted while the user commutes from their home to their workplace.

Typical UEs are equipped with a variety of processing chips and/or processor devices. As UE-related technology advances, such processing chips and/or processing devices are becoming increasingly more powerful. However, this increase in computational power comes at a cost—namely, at the expense of the UE’s battery and/or battery life due to the increased power required to support the processing chips. For instance, typical UEs are operable to perform thousands of measurements and calculations per second. In some situations, not all of the measurements and calculations performed by the UE are necessary. Hence, in those situations, it may be desirable to disable such measurements and calculations in order to conserve the UE’s battery and/or reduce the UE’s overall battery consumption.

Accordingly, example aspects of the present disclosure address the aforementioned power consumption-related issues by intelligently disabling neighbor cell measurements for a UE in situations where the UE does not need to constantly measure all of the neighbor base stations, such as when the UE is in an inactive state (e.g., Radio Resource Control (RRC) idle state), when the UE is in stable RF conditions, when the UE is in the center of its corresponding serving base station’s coverage area and is not moving, and/or the like.

More particularly, as discussed herein, a UE of the present disclosure may obtain location data associated with the UE—such as geolocation data (e.g., Global Positioning System (GPS) coordinates, etc.), serving cell measurements (e.g., characterizing a signal strength of a communication link between the UE and the serving base station), geofencing location data, and/or the like—and based on the location data, the UE may disable neighbor cell measurements for at least one neighbor base station of a plurality of neighbor base stations. For instance, in some examples, the UE may disable neighbor cell measurements for each neighbor base station of the plurality of neighbor base stations. Additionally and/or alternatively, in some examples, the UE may disable neighbor cell measurements for a predetermined subset of neighbor base stations of the plurality of neighbor base stations.

The present disclosure provides a number of technical effects and benefits, including improvements to computing technology. As one example, the present disclosure provides a UE that is operable to intelligently identify situations where a UE does not need to constantly and/or continuously perform neighbor cell measurements. In such situations, a UE of the present disclosure is operable to disable some or all neighbor cell measurements based on location data associated with the UE, thereby reducing overall power draw, increasing battery life and battery longevity, and/or the like. Additionally, subsequent to disabling some or all neighbor cell measurements, a UE of the present disclosure is operable to enable the neighbor cell measurements in response to detecting a change in the location data, thereby reducing a risk of a failed handoff transaction and ensuring the UE maintains optimal connectivity to the wireless communication network. Furthermore, example aspects of the present disclosure provide resulting improvements to computing technology associated with UEs. As one example, reductions in power draw and processing requirements during situations where neighbor cell measurements are disabled may directly improve operation speeds for UEs. Likewise, processing and storage requirements for UEs may be directly reduced, ultimately resulting in more efficient resource use on both the user-side and the service provider-side. In this way, valuable computing resources that would otherwise be needed for neighbor cell measurements may be reserved for other tasks,

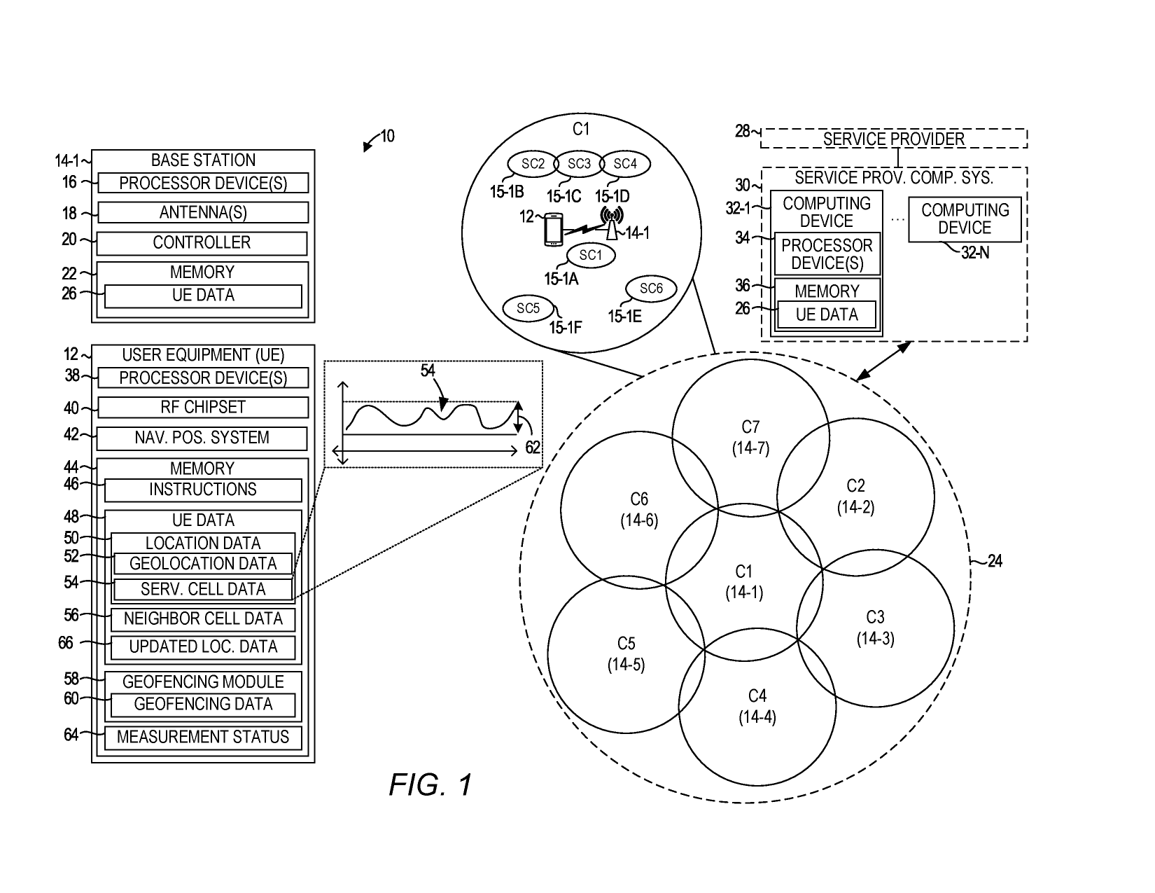

FIG. 1 is a block diagram of an environment 10 suitable for intelligently controlling a neighbor cell measurement mode (e.g., normal operation, reduced neighbor cell measurements, no neighbor cell measurements) of a user equipment (UE) 12 (e.g., mobile phone, tablet, etc.) according to some implementations. The environment 10 includes a plurality of base stations 14-1 – 14-N (generally, base stations 14). The base stations 14 may be any suitable base station, such as multi-sector base stations that serve (e.g., implement) multiple coverage areas, single-sector base stations that serve (e.g., implement) a single coverage area, and/or the like. The base stations 14 may include any suitable wireless base station, such as a 5G base station, a 4G base station, a 3G base station, and/or the like. In some implementations, the base stations 14 may implement Citizens Broadband Radio Service (CBRS), which is a 150 MHz wide broadcast band of the 3.5 GHz band (3550 MHz to 3700 MHz) in the United States. In such implementations, the base stations 14 may include Citizens Broadband Radio Service Devices (CBSDs), such as an Evolved NodeB (eNodeB) or gNodeB (sometimes referred to as gNB) by way of non-limiting example. The examples disclosed herein may also be applied to wireless frequencies defined by standard (FR1 : < 6GHz or FR2 : > 6GHz). While only seven base stations 14 are illustrated, in practice, the environment 10 may have tens, hundreds, or thousands of base stations 14.

The base station 14-1 serves (e.g., implements) a coverage area C1. The base station 14-1 includes a processor device 16, one or more antennas 18, and a memory 22. The one or more antennas 18 are operable to transmit data to and receive data from one or more computing devices, such as the UE 12. The base station 14-1 also includes a base station controller 20 that, inter alia, provides antenna configuration instructions to the antenna(s) 18. The base station 14-1 may monitor and store (e.g., in memory 22) antenna configuration information, which includes data indicative of the current configuration of the antenna(s) 18 (e.g., a location of the antennas 18, a height of the antennas 18, an azimuth of the antennas 18, a tilt of the antennas 18, a physical cell ID (PCI) of the coverage area C1, frequencies used by the antennas 18, etc.).

The base station 14-1 may establish a communication link with one or more computing devices and provide network access to the wireless communication network 24. The wireless communication network 24 may be any suitable wireless communication network (e.g., cellular network), such as a 5G network, a 4G network, a 3G network, and/or the like. The base station 14-1 may also obtain and/or maintain a variety of real-time metrics associated with each computing device (e.g., each communication link). For instance, in the example of FIGURE1, the base station 14-1 has a communication link with, and is providing service to, the UE 12. The base station 14-1 may obtain and maintain real-time UE data 26, such as real-time UE metrics, associated with the UE 12. By way of non-limiting example, the real-time UE data 26 may include a location identifier identifying a location of the UE 12, a signal strength and/or signal quality of the communication link between the UE 12 and the base station 14-1 (e.g., average power received from a single reference signal (RSRP), a signal to noise ratio (SINR), etc.), and/or the like. It should be understood that the base station 14-1 is depicted in FIG. 1 as serving only one UE for purposes of illustration and discussion. In practice, the base station 14-1 may serve any number of UEs simultaneously.

The base stations 14-2 – 14-7 may be configured substantially similarly to the base station 14-1 and maintain identical or substantially similar information for each antenna and each computing device served by the respective base station 14. It should be understood that the coverage areas C1–C7 are depicted inFIG. 1 as being substantially similar in shape. However, in practice the coverage areas C1–C7 may have any suitable shape and may be differ substantially from one another.

The base stations 14-1 – 14-7 form part of the wireless communication network 24. The wireless communication network 24 may be operated by a service provider 28. The service provider 28 operates a service provider computing system 30, which includes one or more computing devices 32-1 – 32-N (collectively, computing device 32). The computing device 32 includes a processor device 34 and a memory 36. The service provider 28 may obtain and maintain data associated with each base station 14 and each computing device having a communication link with one of the base stations 14. For instance, in the example depicted in FIGURE1, the service provider 28 may obtain and maintain the real-time UE data 26.

As noted above, the base stations 14 may provide network access to the wireless communication network 24 to a variety of computing devices, such as the UE 12. The UE 12 includes a processor device 38 and a memory 44. The UE 12 also includes a radio frequency (RF) chipset 40, which is operable to transmit data to and receive data from the wireless communication network 24. The UE 12 also includes a variety of sensors, such as a navigation positioning system 42 operable to obtain geolocation data associated with a physical location of the UE 12. For instance, in some implementations, the navigation positioning system 42 may be a Global Positioning System (GPS) device operable to obtain GPS coordinates associated with the physical location of the UE 12.

The UE 12 also includes a memory 44. The memory 44 includes executable instructions 46 that, when executed, cause the processor device 38 to perform operations, such as the operations described herein. The memory 44 also includes real-time UE data 48 that may, in some implementations, be obtained by the UE 12. More particularly, the UE 12 may obtain real time UE data and/or real-time UE metrics (e.g., real-time UE data 48) that quantify signal characteristics between the UE 12 and a serving base station of the wireless communication network 24 which, in the example depicted in Figure 1, is base station 14-1. The UE 12 may periodically obtain the real time UE data and/or real-time UE metrics (e.g., real-time UE data 48), such as every 500 milliseconds, every second, every five seconds, and/or the like.

For instance, the UE 12 may obtain location data 50. By way of non-limiting example, the location data 50 may include geolocation data 52 (e.g., GPS coordinates, device location information) that corresponds to a physical location of the UE 12. The location data 50 may also include serving cell measurements, such as serving cell data 54, that characterizes the communication link between the UE 12 and the serving base station (e.g., base station 14-1). By way of non-limiting example, the serving cell data 54 may include serving cell signal strength, interference metrics, coverage level metrics, channel quality metrics, physical cell id associated with the serving base station, network slice identifier of the network slice to which the UE 12 has been assigned, device location information that identifies a location of the UE 12, and/or the like. In some implementations, the UE 12 may send the location data 50 to the base station 14-1 and, hence, the service provider computing system 30.

The UE 12 may also obtain real time UE data and/or real-time UE metrics that quantify signal characteristics between the UE 12 and each neighbor base station of the wireless communication network 24. For instance, the UE data 48 may include neighbor cell data 56. As noted above, neighbor base stations are base stations that are adjacent to the serving base station (e.g., base station 14-1) which, in the example depicted in FIGURE1, are base stations 14-2 – 14-7. By way of non-limiting example, the neighbor cell data 56 may include interference metrics, coverage level metrics, channel quality metrics, and/or the like. In some implementations, the UE 12 may send the neighbor cell data 56 to the respective base stations 14-2 – 14-7 and, hence, the service provider computing system 30.

With this background, an example of intelligently configuring a neighbor cell measurement mode (e.g., normal operation, reduced neighbor cell measurements, no neighbor cell measurements) of the UE 12 will be discussed. As described herein, there are various situations where the UE 12 may not need to obtain neighbor cell measurements associated with the plurality of neighbor base stations (e.g., base stations 14-2 – 14-7). As one example, neighbor cell measurements are unnecessary when the UE 12 is in an RRC idle state, when the UE 12 is stationary (or moving slowly such that the UE 12 will stay within the coverage area C 1of the base station 14-1), when the UE 12 has stable connectivity to the wireless communication network 24, and/or the like.

As described herein, the UE 12 may be served by the base station 14-1 when the UE is within the coverage area C1 of the base station 14-1. In particular, the UE 12 may establish a communication link the base station 14-1 to access the wireless communication network 24. During normal operation, the UE 12 obtains a variety of real-time UE data and/or real-time UE metrics associated with the base station 14-1 (e.g., serving base station) and the base stations 14-2 – 14-7 adjacent the base station 14-1 (e.g., neighbor base stations), such as serving cell measurements (e.g., serving cell data 54) and neighbor cell measurements (e.g., neighbor cell data 56), respectively.

The UE 12 may determine its physical location in a variety of different ways, such as triangulation, paging, GPS coordinates, and/or the like. As one example, the UE 12 may obtain location data 50 associated with the UE 12 for a plurality of sampling periods, such as geolocation data 52 corresponding to a physical location of the UE 12 (e.g., from the navigation positioning system 42), serving cell measurements (e.g., serving cell data 54) associated with the base station 14-1 (e.g., characterizing a signal strength of the communication link between the UE 12 and the base station 14-1), and/or the like. Based on the location data 50, the UE 12 may disable neighbor cell measurements for at least one neighbor base station (e.g., base stations 14-2 – 14-7), which, as described herein, characterize a signal strength of a communication link between the UE 12 and the at least one neighbor base station (e.g., base stations 14-2 – 14-N). In some implementations, neighbor cell measurements may be disabled for each neighbor base station (e.g., no neighbor cell measurements) of the plurality of neighbor base stations (e.g., base stations 14-2 – 14-7). For instance, in some implementations, the UE 12 may be operable in a “serving-cell-only mode” (e.g., “no neighbor-cell-measurement mode”) in which the UE 12 only obtains serving cell measurements (e.g., serving cell data 54) for the serving base station (e.g., base station 14-1) and does not obtain any neighbor cell measurements (e.g., neighbor cell data 56) for any respective neighbor base station (e.g., base stations 14-2 – 14-7). Additionally and/or alternatively, in some implementations, the neighbor cell measurements may be disabled for a subset of neighbor base stations, such as a predetermined number of base stations 14-2 – 14-7 (e.g., reduced neighbor cell measurements). The subset of neighbor base stations (e.g., base stations 14-2 – 14-7) may be determined in any suitable manner, such as a percentage reduction of neighbor base stations (e.g., less than 50% of neighbor base stations, less than 25% of neighbor base stations, less than 10% of neighbor stations, etc.), a location-based reduction of neighbor base stations (e.g., neighbor bast stations within a threshold distance of the serving base station), and/or the like. For instance, in some implementations, the UE 12 may be operable in a “reduced-neighbor-cell mode” in which the UE 12 obtains serving cell measurements (e.g., serving cell data 54) for the serving base station (e.g., base station 14-1) and only obtains neighbor cell measurements (e.g., neighbor cell data 56) for a subset of neighbor base stations (e.g., base stations 14-2 – 14-7). Put differently, in the “reduced-neighbor-cell mode,” the UE 12 may disable neighbor cell measurements (e.g., neighbor cell data 54) for at least one—but not all—neighbor base station (e.g., one, but not all, of base stations 14-2 – 14-7). Additionally and/or alternatively, in the ”reduced-neighbor-cell mode,” the UE 12 may also decrease a number of neighbor cell measurements it obtains over the plurality of sampling periods.

More particularly, the UE 12 may determine whether the UE 12 is stationary (or slowly moving) based on the geolocation data 52 and the serving cell measurements (e.g., serving cell data 54). In some examples, the UE 12 may determine whether the UE 12 is stationary by comparing the geolocation data 52 (e.g., obtained by the navigation positioning system 42) for the plurality of sampling periods. For instance, the UE 12 may determine it is in motion based on a fluctuation in the serving cell data 54 over the sampling period. In some implementations, the UE 12 may determine whether the UE 12 is stationary by comparing a signal strength metric associated with the communication link between the UE 12 and the base station 14-1 over the plurality of sampling periods.

The UE 12 may also determine a serving-cell location of the UE 12 based on the geolocation data 52 and the serving cell measurements (e.g., serving cell data 54). The serving-cell location corresponds to a location of the UE 12 within a coverage area of the serving base station (e.g., base station 14-1), such as the coverage area C1. In some examples, the UE 12 may determine that the physical location of the UE 12 corresponds to a central portion of the coverage area C1 of the base station 14-1. For instance, as the UE 12 approaches the central portion of the coverage area C1, the serving cell data 54 (e.g., recorded signal strength) will increase over the plurality of sampling periods. Conversely, as the UE 12 approaches a peripheral portion of the coverage area C1, the serving cell data 54 (e.g., recorded signal strength) will decrease over the plurality of sampling periods. Based on the serving-cell location of the UE 12 (e.g., corresponding to a central portion of the coverage area C1), the UE 12 may disable the neighbor cell measurements for at least one neighbor base station (e.g., base stations 14-2 – 14-7) in response to determining the UE 12 is stationary.

In some implementations, to determine the serving-cell location of the UE 12, the UE 12 may obtain geofencing location data 60 from a serving sub-station of the wireless communication network 24. More particularly, in some implementations, the wireless communication network 24 may include one or more sub-stations that supplement wireless connectivity within a coverage area of a base station, such as sub-stations 15-1A – 15-1F (collectively, sub-stations 15-1) within the coverage area C1 of the base station 14-1. The sub-stations 15-1A – 15-1F may be implemented by the same service provider 28 as the corresponding base station 14-1 and/or a different service provider. The sub-station 15-1A – 15-1F may have a higher operating frequency than the corresponding base station 14-1 and, hence, may have a smaller coverage area SC1–SC6 relative to the coverage area C1 of the base station 14-1. As such, in some implementations, voice data (e.g., phone calls) of the UE 12 may go through the base station 14-1, while other data (e.g., text messages, emails, downloads, etc.) may go through one of the sub-stations 15-1A – 15-1F.

The presence of the sub-stations 15-1A – 15-1F within the coverage area C1 of the base station 14-1 also enables the UE 12 to perform geofencing operations. As an illustrative example, if the UE 12 is within the coverage area SC1 of the sub-station 15-1A, the UE 12 may establish a communication link with the sub-station 15-1A. In this example, the sub-station 15-1A is a serving sub-station for the UE 12. The UE 12 may include a connection controller, such as a geofencing module 58, stored in the memory 44, which is configured to obtain and store the geofencing location data 60 from the sub-station 15-1A. The UE 12 may determine a location of the coverage area SC1 of the sub-station 15-1A (e.g., serving sub-station) relative to the coverage area C1 of the base station 14-1 (e.g., serving base station) based on the geofencing location data 60. In this way, the UE 12 is able to determine whether its physical location is in a central portion or a peripheral portion of the coverage area C1 based on the geofencing location data 60. In the example depicted in FIGURE1, the coverage area SC1 is in a central portion of the coverage area C1, while the coverage areas SC2–SC6 are in peripheral portions of the coverage area C1.

In some implementations, the UE 12 may determine whether the serving cell measurements (e.g., serving cell data 54) are within a threshold range 62 of signal strength measurements. The threshold range 62 may include signal strength measurements that indicate the UE 12 is in stable radio frequency (RF) conditions at the physical location of the UE 12. In such examples, in response to determining that the serving cell measurements (e.g., serving cell data 54) are within the threshold range 62, the UE 12 may disable the neighbor cell measurements for at least one neighbor base station (e.g., base stations 14-2 – 14-7).

Subsequent to disabling the neighbor cell measurements, the UE 12 may provide measurement status data 64 and the location data 50 to the service provider computing system 30. In particular, the measurement status data 64 may indicate that the UE 12 has disabled the neighbor cell measurements for the at least one neighbor base station (e.g., base stations 14-2 – 14-7).

Additionally, the UE 12 may continue obtaining the location data 50 (e.g., updated location data 66) and may, subsequent to disabling the neighbor cell measurements, detect a change in the location data 50 based on the updated location data 66. In response to detecting the change in the location data 50, the UE 12 may determine a predicted movement path for the UE 12. The UE 12 may determine the predicted movement path based on the updated location data 66. In some implementations, in response to determining the predicted movement path of the UE 12, the UE 12 may enable the neighbor cell measurements for each base station 14.

For instance, to determine the predicted movement path of the UE 12, the UE 12 may determine a movement direction and a movement speed of the UE 12 based on the location data 50 and the updated location data (e.g., by comparing the updated location data to the location data 50). Based on the movement direction and the movement speed, the UE 12 may determine a predicted location of the UE 12. In some implementations, the UE 12 may determine the predicted location of the UE 12 is outside the coverage area C1 of the base station 14-1 (e.g., the serving base station) and/or at a peripheral location of the coverage area C1 of the base station 14-1 (e.g., the serving base station). In response, the UE 12 may enable the neighbor cell measurements for each base station 14 to ensure a handoff-related error does not materialize.

Subsequent to enabling the neighbor cell measurements, the UE 12 may obtain neighbor cell measurements (e.g., neighbor cell data 56) for each base station 14 of the wireless communication network 24. The UE 12 may also provide measurement status data 64, which indicates the UE 12 has enabled the neighbor cell measurements for each neighbor base station (e.g., base stations 14-2 – 14-7) to the service provider computing system 30.

It should be understood that the wireless communication network 24 depicted in FIG. 1 is for purposes of illustration and discussion. Those having ordinary skill in the art, using the disclosures provided herein, will understand that a wireless communication network may have any number of base stations, sub-stations, coverage areas, etc. without deviating from the scope of the present disclosure.

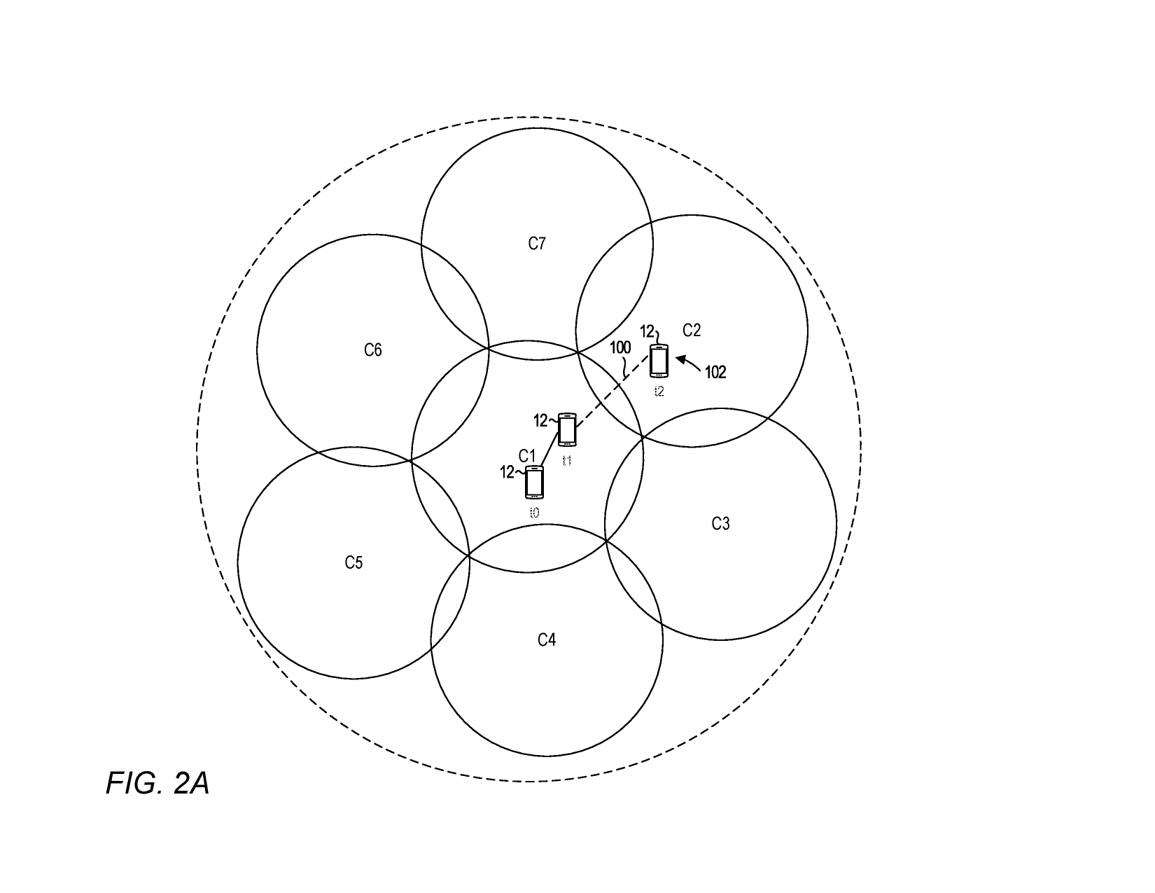

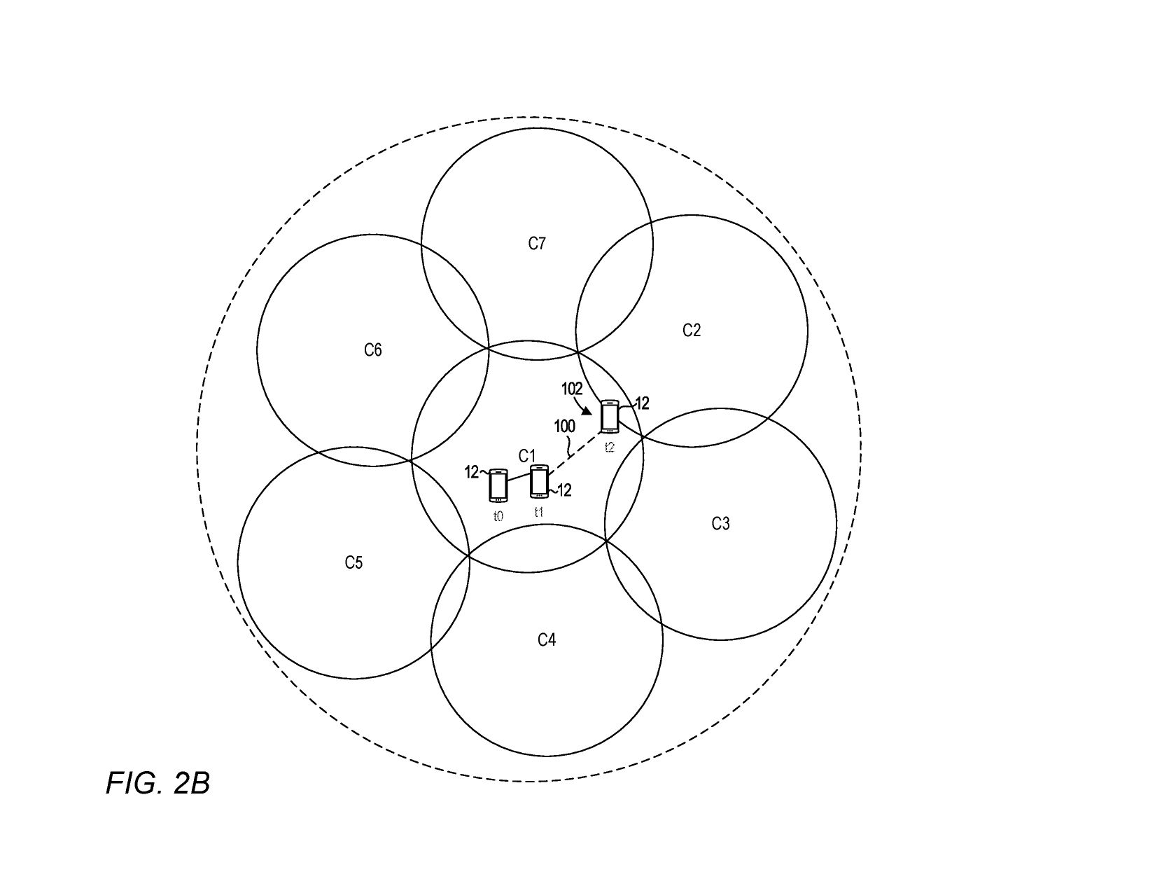

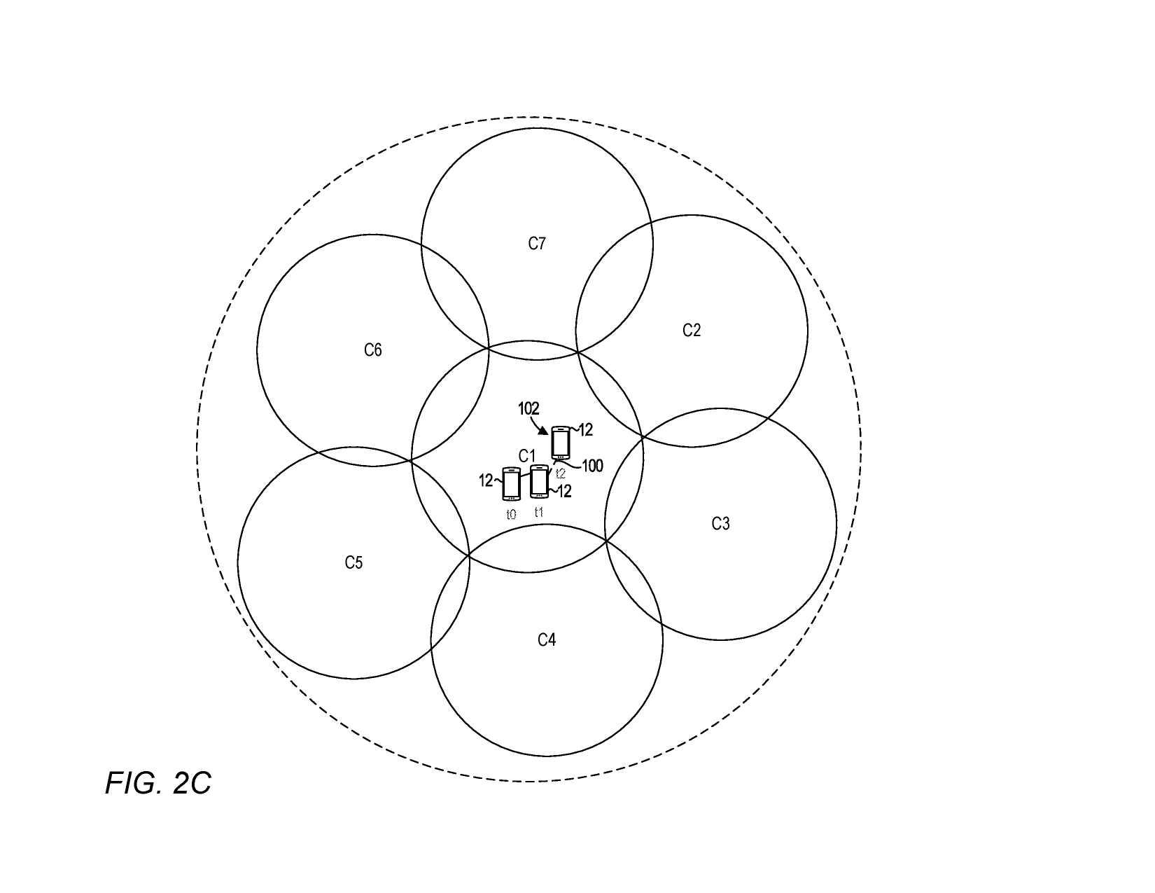

FIGS. 2A-2C depict illustrative examples of the neighbor cell measurement operations described herein according to some implementations FIGS. 2A-2C. will be discussed in conjunction with FIG. 1

Referring now to FIG. 2A, the UE 12 is within coverage area C1 and, hence, is being served by the base station 14-1 at time t0. Similarly, the UE 12 is also within the coverage area C1 and, hence, is still being served by the base station 14-1 at time t1. The UE 12 may obtain location data 50 (e.g., geolocation data 52, serving cell data 54) for a plurality of sampling periods (e.g., between times t0 and t1). Based on the location data 50, the UE 12 may determine a predicted movement path 100 for the UE 12. In particular, the UE 12 may determine a movement direction and a movement speed of the UE 12 based on the location data 50 obtained between time t0 and time t1. As such, the UE 12 is able to determine a predicted location 102 of the UE 12 at a future time t2 based on the movement direction and movement speed of the UE 12 between time t0 and time t1. In the illustrative example of FIGURE2A, the predicted location 102 of the UE 12 at time t2 is outside of the coverage area C1 of the base station 14-1 (e.g., in the coverage area C2 of the base station 14-2). As a practical example, suppose the neighbor cell measurements are enabled at time t0. At time t1, the UE 12 would not disable neighbor cell measurements because the predicted movement pattern 100 indicates that, at time t2, the UE 12 is likely to be outside of the coverage area C1 (e.g., a handoff transaction is likely between time t1 and time t2). As another practical example, suppose the neighbor cell measurements are disabled at time t0. At time t1, the UE 12 would enable neighbor cell measurements because the predicted movement pattern indicates that, at time t2, the UE 12 is likely to be outside of the coverage area C1 (e.g., a handoff transaction is likely between time t1 and time t2).

Referring now to Figure 2B, the UE 12 is within the coverage area C1 and, hence, is being served by the base station 14-1 at time t0. Similarly, the UE 12 is also within the coverage area C1 and, hence, is still being served by the base station 14-1 at time t1. As described above, the UE 12 may obtain location data 50 (e.g., geolocation data 52, serving cell data 54) for a plurality of sampling periods (e.g., between times t0 and t1). Based on the location data 50, the UE 12 determines the predicted movement path 100 for the UE 12. The UE 12 determines (e.g., based on the movement direction and movement speed of the UE 12) the predicted location 102 of the UE 12 at a future time t2, which, in contrast to the illustrative example of Figure 2A, is at a peripheral portion of the coverage area C1 of the base station 14-1. As a practical example, suppose the neighbor cell measurements are enabled at time t0. At time t1, the UE 12 would not disable neighbor cell measurements because the predicted movement pattern 100 indicates that, at time t2, the UE 12 is likely to be at a peripheral portion of the coverage area C1 (e.g., a handoff transaction is likely between time t1 and time t2). As another practical example, suppose the neighbor cell measurements are disabled at time t0. At time t1, the UE 12 would enable neighbor cell measurements because the predicted movement pattern indicates that, at time t2, the UE 12 is likely to be at a peripheral portion of the coverage area C1 (e.g., a handoff transaction is likely between time t1 and time t2).

Referring now to FIG. 2C the UE 12 is within the coverage area C1 and, hence, is being served by the base station 14-1 at time t0. Similarly, the UE 12 is also within the coverage area C1 and, hence, is still being served by the base station 14-1 at time t1. As described above, the UE 12 may obtain location data 50 (e.g., geolocation data 52, serving cell data 54) for a plurality of sampling periods (e.g., between times t0 and t1). Based on the location data 50, the UE 12 determines the predicted movement path 100 for the UE 12. The UE 12 determines (e.g., based on the movement direction and movement speed of the UE 12) the predicted location 102 of the UE 12 at a future time t2, which, in contrast to the illustrative example of Figures2A–2B, is at a central portion of the coverage area C1 of the base station 14-1. As a practical example, suppose the neighbor cell measurements are enabled at time t0. At time t2, the UE 12 would disable neighbor cell measurements because the predicted movement pattern 100 indicates that, at time t2, the UE 12 is likely to be in stable RF conditions, such as at a central portion of the coverage area C1 (e.g., a handoff transaction is not likely between time t1 and time t2). As another practical example, suppose the neighbor cell measurements are disabled at time t0. At time t1, the UE 12 would not enable neighbor cell measurements because the predicted movement pattern 100 indicates that, at time t2, the UE 12 is likely to be in stable RF conditions, such as at the central portion of the coverage area C1 (e.g., a handoff transaction is not likely between time t1 and time t2).

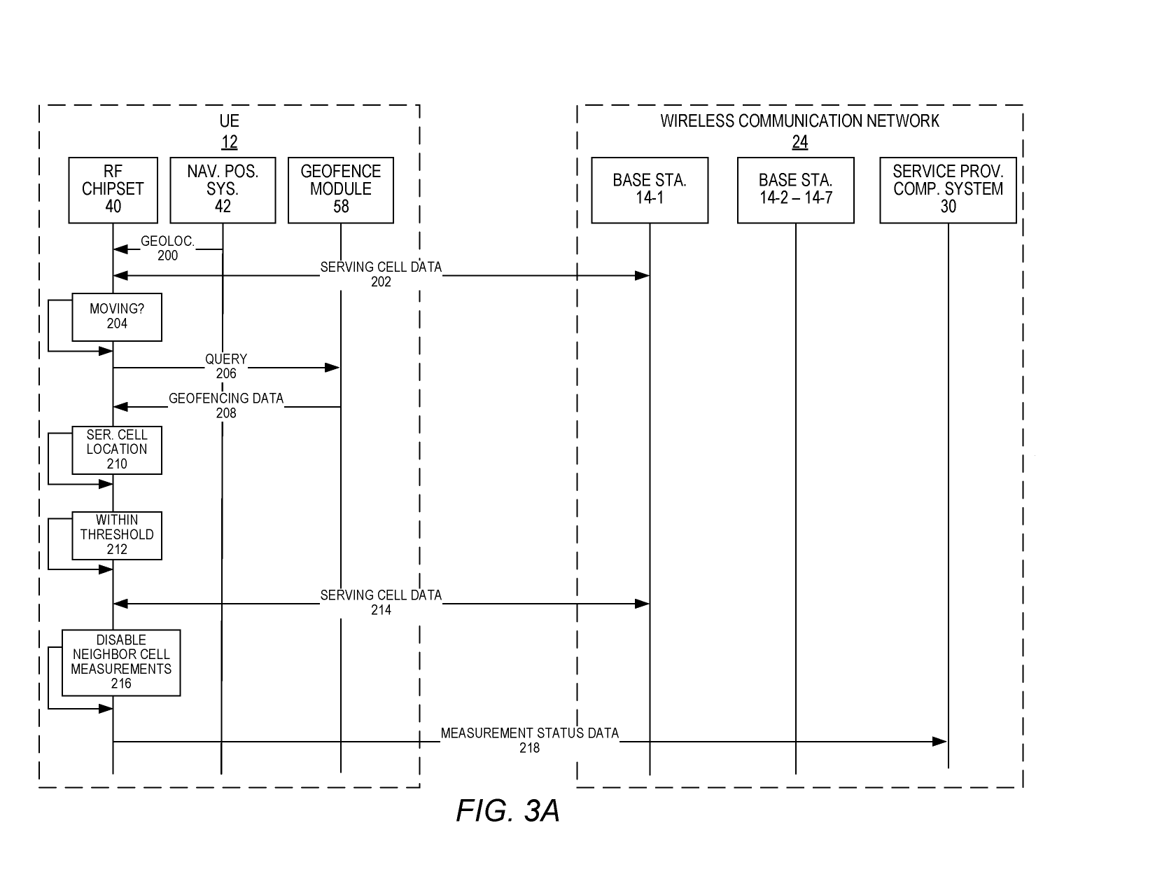

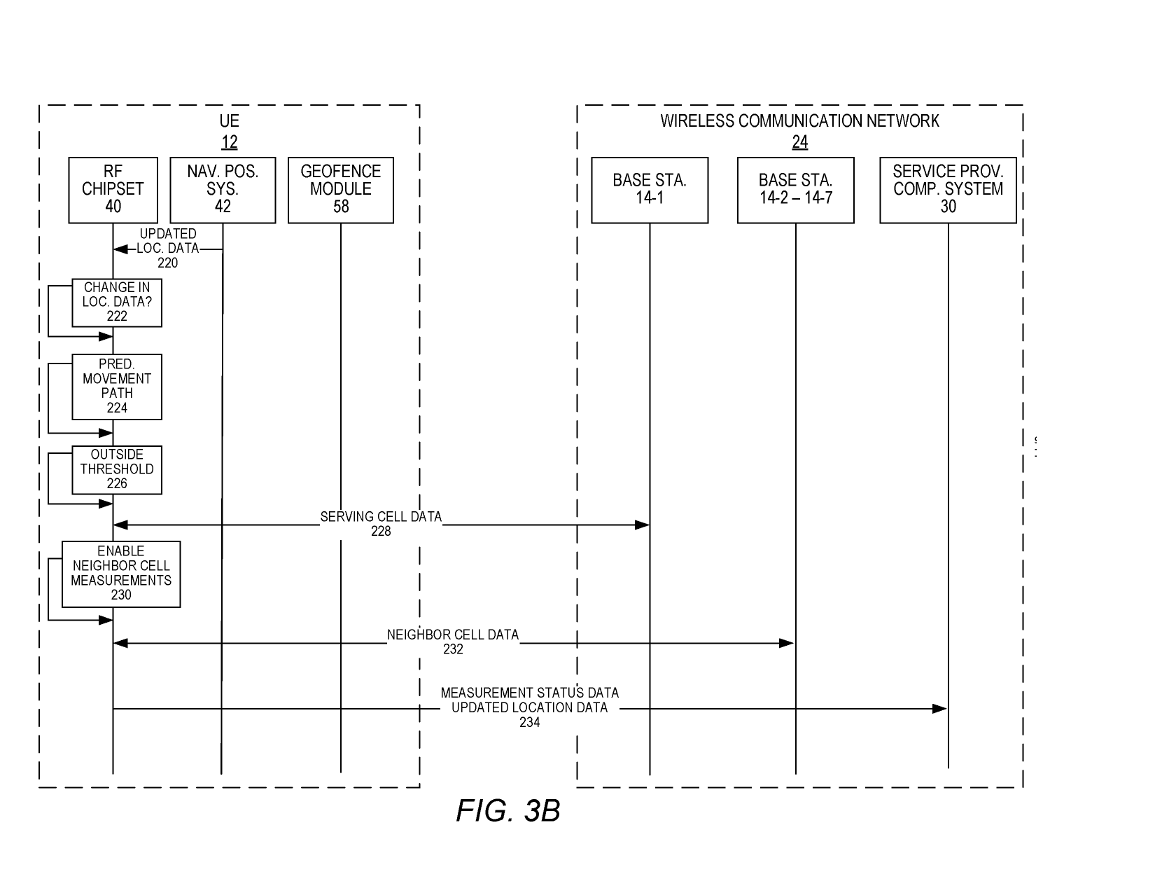

FIGS. 3A-3B are a sequence diagrams illustrating messages communicated between and actions taken by certain components illustrated in FIG. 1 to intelligently disable neighbor cell measurements according to one implementation of the present disclosure. FIGS. 3A-3B will be discussed in conjunction with FIG. 1.

Referring to FIG. 3A, the UE 12 (e.g., via navigation positioning system 42) obtains geolocation data 52 associated with the UE 12, which corresponds to a physical location of the UE 12, for a plurality of sampling periods (FIG. 3A, step 200). For instance, the UE 12 may obtain GPS coordinates via the navigation positioning system 42. The UE 12 (e.g., via RF chipset 40) obtains serving cell measurements (e.g., serving cell data 54) associated with the base station 14-1 (e.g., serving base station) that characterize a signal strength of a communication link between the UE 12 and the base station 14-1 for the plurality of sampling periods (FIG. 3A step 202). Based on the geolocation data 52 and the serving cell measurements (e.g., serving cell data 54), the UE 12 determines that the UE 12 is stationary for the plurality of sampling periods (FIG. 3A, step 204). In response, the UE 12 queries a geofence module 58 (FIG. 3A, step 206) and receives geofencing location data 60 from the geofence module 58 (FIG. 3A, step 208).

Based on the geolocation data 52, the serving cell measurements (e.g., serving cell data 54), and the geofencing location data 60, the UE 12 determines a serving-cell location of the UE 12 corresponds to a central portion of the coverage area C1 of the base station 14-1 (e.g., serving base station) (FIG. 3A, step 210). The UE 12 then compares the serving cell measurements (e.g., serving cell data 54) to a threshold range 62 of signal strength measurements (e.g., indicative of stable RF conditions) and determines the serving cell measurements (e.g., serving cell data 54) are within the threshold range 62 (FIG. 3A, step 212). In response, the UE 12 continues to obtain the serving cell measurements (e.g., serving cell data 54) associated with the base station 14-1 (e.g., serving base station) (FIG. 3A, step 214) and disables neighbor cell measurements for at least one neighbor base station (e.g., base stations 14-2 – 14-7) (FIG. 3A, step 216). Subsequent to disabling the neighbor cell measurements, the UE 12 provides measurement status data 64 (e.g., indicating the UE 12 disabled the neighbor cell measurements) to the service provider computing system 30 ( FIG. 3A, step 218).

Referring toFIG. 3B the UE 12 obtains updated location data 66 associated with the UE 12 for a plurality of sampling periods (FIGURE3B, step 220). Based on the updated location data 66, the UE 12 detects a change in the location data 50 (FIG. 3B, step 222). In response to detecting the change in the location data 50, the UE 12 determines a predicted movement path (e.g., predicted movement path 100 (FIGS. 2A-2C) for the UE 12 based on the updated location data 66 (FIG. 3B, step 224). In response to determining the predicted movement path, the UE 12 determines that the serving cell measurements (e.g., serving cell data 54) are outside of the threshold range 62 of signal strength measurements indicative of stable RF conditions (FIGURE3B, step 226). The UE 12 continues to obtain serving cell measurements (e.g., serving cell data 54) from the base station 14-1 (e.g., serving base station) (FIGURE3B, step 228) and enables the neighbor cell measurements for the base stations 14-2 – 14-7 (e.g., neighbor base stations) (FIG. 3B, step 230). Subsequently, the UE 12 obtains neighbor cell measurements (e.g., neighbor cell data 56) from each respective base station 14-2 – 14-7 (FIG. 3B, step 232). Subsequent to enabling the neighbor cell measurements, the UE 12 provides measurement status data 64 (e.g., indicating the UE 12 enabled the neighbor cell measurements) and the updated location data 66 to the service provider computing system 30 (FIG. 3B, step 234).

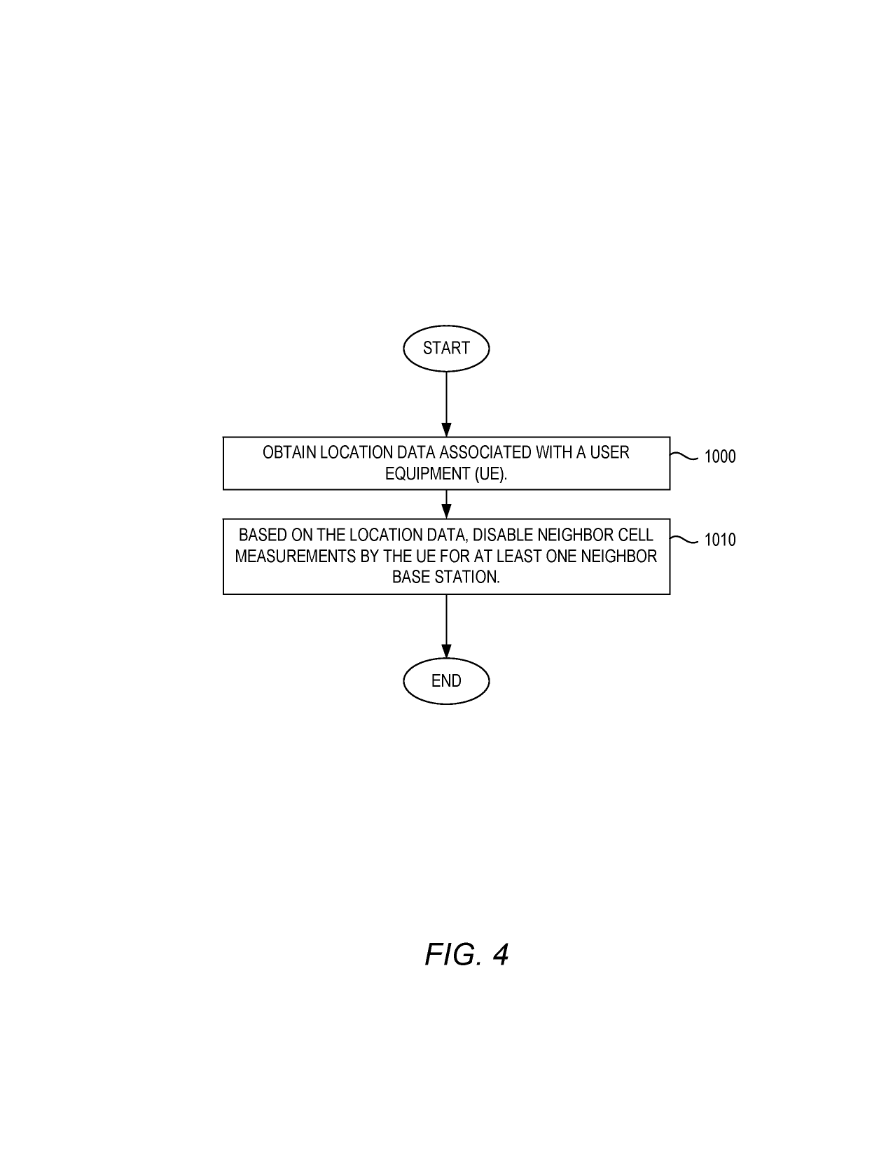

Figure 4 is a flowchart of an example method for intelligently disabling neighbor cell measurements according to one implementation of the present disclosure. Figure 4 will be discussed in conjunction with Figure 1. The UE 12 obtains, from a serving base station (e.g., base station 14-1) of the wireless communication network 24, location data 50 associated with the UE 12 (Figure 4, block 1000). Based on the location data 50, the UE 12 disables neighbor cell measurements for at least one neighbor base station (e.g., base stations 14-2 – 14-7), which characterize a signal strength of a communication link between the UE 12 and the at least one neighbor base station (e.g., base stations 14-2 – 14-7) (Figure 4, block 1010).

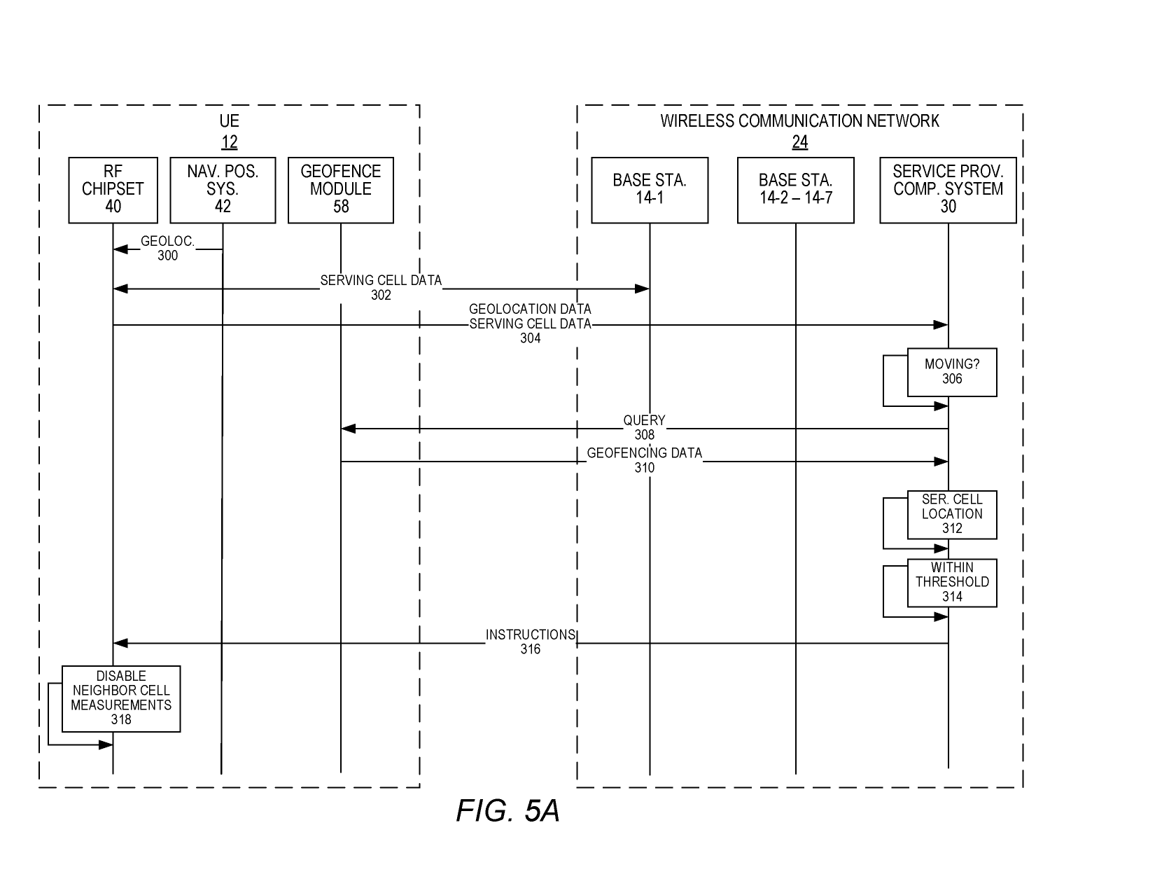

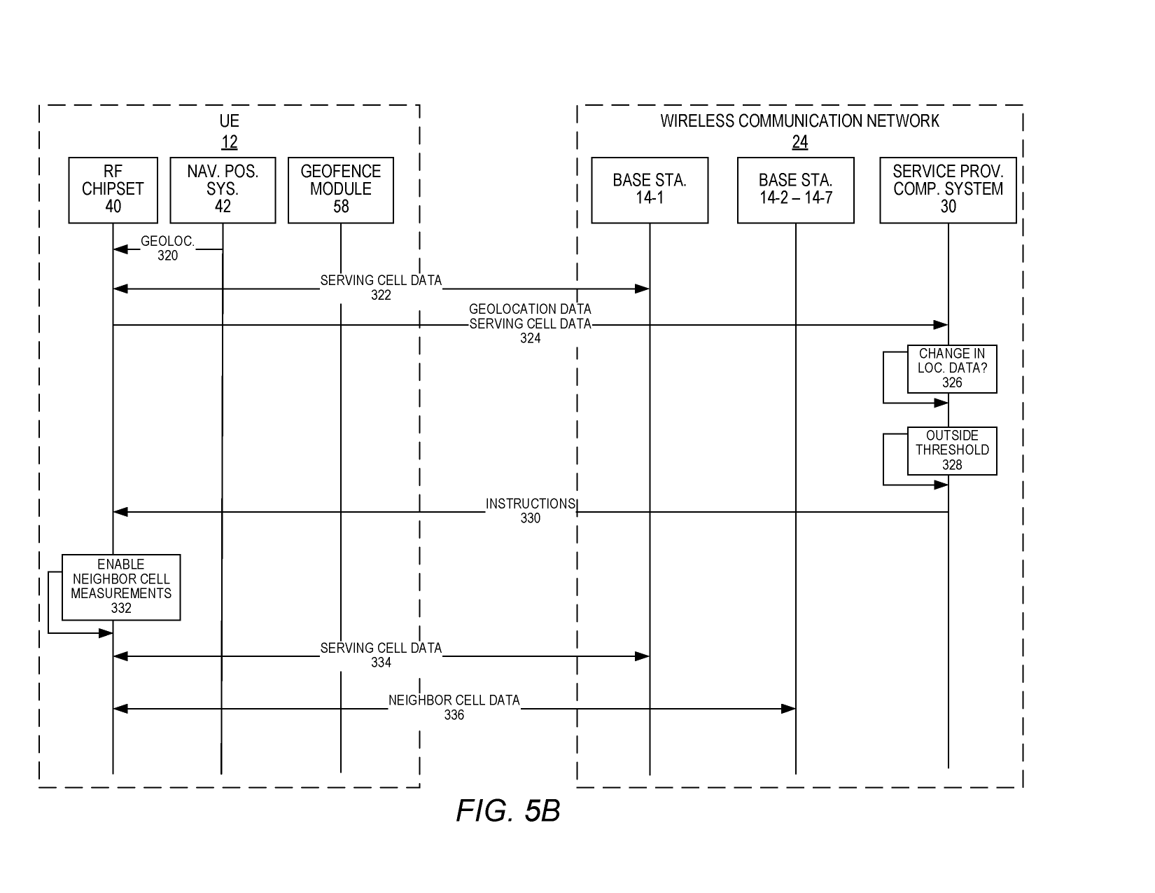

FIGS. 5A-5B are a sequence diagrams illustrating messages communicated between and actions taken by certain components illustrated in FIG. 1 to intelligently disable neighbor cell measurements according to one implementation of the present disclosure. FIGS. 5A-5B will be discussed in conjunction with FIG. 1.

Referring to FIG. 5A, the UE 12 obtains, for a plurality of sampling periods, geolocation data 52 associated with the UE 12FIG. 5A, step 300). The UE 12 obtains, for the plurality of sampling periods, serving cell measurements (e.g., serving cell data 54) associated with the base station 14-1 (e.g., serving base station) that characterize a signal strength of a communication link between the UE 12 and the base station 14-1 (FIG. 5A, step 302). The UE 12 provides the geolocation data 52 and the serving cell data 54 to the service provider computing system 30 (, step 304). Although not depicted in FIG. 5A, the UE 12 also obtains neighbor cell measurements (e.g., neighbor cell data 56) that characterize the signal strength of respective communication links between the UE 12 and respective neighbor base stations (e.g., base stations 14-2 – 14-7).

The service provider computing system 30 receives the geolocation data 52 and the serving cell data 54 and, based on the received data, determines that the UE 12 is stationary for the plurality of sampling periods (FIG. 5A, step 306). The service provider computing system 30 may determine whether the UE 12 is stationary in any suitable manner, such as using any of the operations described herein with reference to the UE 12. In response to determining that the UE 12 is stationary, the service provider computing system 30 queries the geofence module 58 of the UE 12 (FIGURE5A, step 308), which provides geofencing location data 60 associated with the UE 12 to the service provider computing system 30 (FIG. 5A, step 310).

Based on the geolocation data 52, the serving cell measurements (e.g., serving cell data 54), and the geofencing location data 60, the service provider computing system 30 determines a serving-cell location of the UE 12 corresponds to a central portion of the coverage area C1 of the base station 14-1 (e.g., serving base station) FIG. 5A, step 312). The service provider computing system 30 then compares the serving cell measurements (e.g., serving cell data 54) to a threshold range 62 of signal strength measurements (e.g., indicative of stable RF conditions) and determines the serving cell measurements (e.g., serving cell data 54) are within the threshold range 62 (FIG. 5A, step 314). In response, the service provider computing system 30 provides instructions to the UE 12 (FIG. 5A, step 316) that cause the UE 12 to disable neighbor cell measurements for at least one neighbor base station (e.g., base stations 14-2 – 14-7) (FIG. 5A, step 318).

Referring to FIG. 5B, subsequent to disabling the neighbor cell measurements, the UE 12 continues to obtain, for a plurality of sampling periods, geolocation data 52 (FIG. 5B, step 320) and serving cell measurements (e.g., serving cell data 54) (FIG. 5B, step 322). The UE 12 provides the updated location data (e.g., geolocation data 52, serving cell data 54) to the service provider computing system 30 (FIG. 5B, step 324). The service provider computing system 30 receives the updated location data (e.g., geolocation data 52, the serving cell data 54) and, based on the updated location data, detects a change in the location data 50 (FIG. 5B, step 326). In response to detecting the change, the service provider computing system 30 determines that the serving cell measurements (e.g., serving cell data 54) are outside of the threshold range 62 of signal strength measurements indicative of stable RF conditions (FIG. 5B, step 328). In response, the service provider computing system 30 provides instructions to the UE 12 (FIG. 5B step 330) that cause the UE 12 to enable neighbor cell measurements for the base stations 14-2 – 14-7 (FIG. 5B step 332). Subsequently, the UE 12 continues to obtain serving cell measurements (e.g., serving cell data 54) from the base station 14-1 (e.g., serving base station) (FIGURE5B, step 334) and resumes obtaining neighbor cell measurements (e.g., neighbor cell data 56) from the base stations 14-2 – 14-7 (e.g., neighbor base stations) (FIG. 5B step 336).

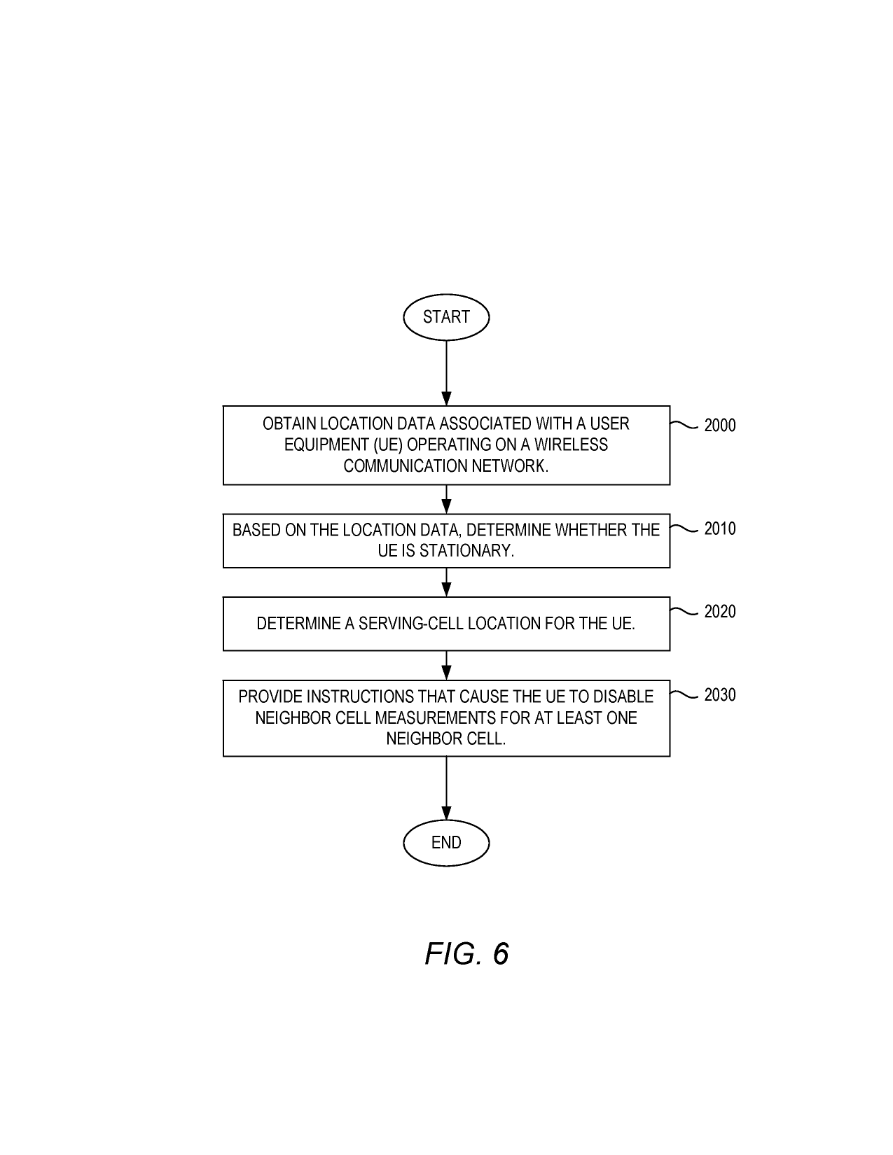

FIG. 6 is a flowchart of an example method for intelligently disabling neighbor cell measurements according to one implementation of the present disclosure. FIGURE6 will be discussed in conjunction with FIG. 1. The service provider computing system 30 obtains location data 50 (e.g., geolocation data 52, serving cell data 54) associated with the UE 12, which is operating on the wireless communication network 24 (e.g., served by the base station 14-1) (FIG. 1, block 2000). Based on the location data 50, the service provider computing system 30 determines whether the UE 12 is stationary (FIG. 6, block 2010). In response to determining the UE 12 is stationary, the service provider computing system 30 determines a serving-cell location for the UE 12 (FIG. 6, block 2020). In response to determining the serving-cell location for the UE 12, the service provider computing system 30 provides instructions to the UE 12 that cause the UE 12 to disable neighbor cell measurements for at least one neighbor base station (e.g., base station 14-2 – 14-7), which characterize a signal strength of a communication link between the UE 12 and the at least one neighbor base station (e.g., base station 14-2 – 14-7) (FIG. 6, block 2030).

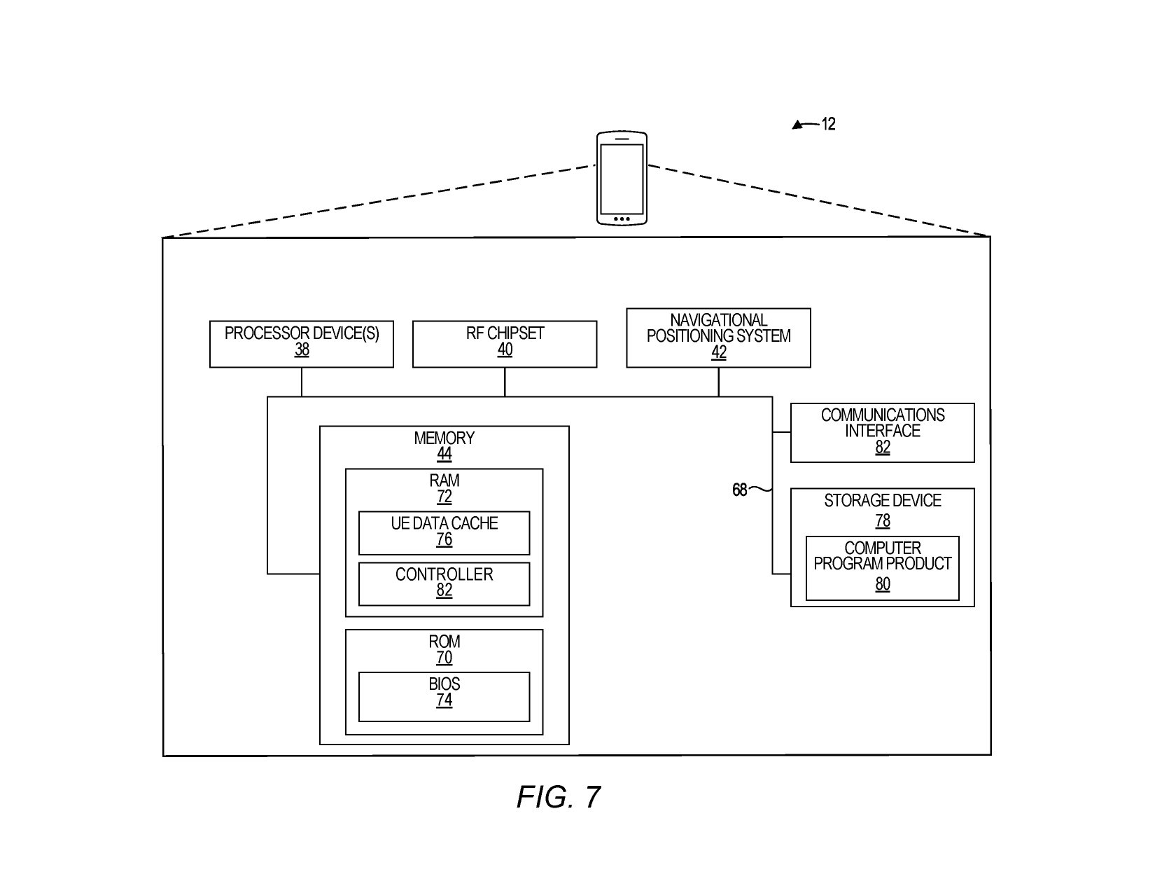

FIG. 7 is a block diagram of the user equipment (UE) 12 suitable for implementing examples disclosed herein. The UE 12 may be any suitable computing device, such as a mobile phone, a mobile tablet device, and/or the like. The UE 12 includes the processor device(s) 38, a system memory (e.g., memory 44), and a system bus 68. The system bus 68 provides an interface for system components including, but not limited to, the memory 44 and the processor device(s) 38. The processor device(s) 38 may be any commercially available or proprietary processor.

The system bus 68 may be any of several types of bus structures that may further interconnect to a memory bus (with or without a memory controller), a peripheral bus, and/or a local bus using any of a variety of commercially available bus architectures. The memory 44 may include non-volatile memory 70 (e.g., read-only memory (ROM), erasable programmable read-only memory (EPROM), electrically erasable programmable read-only memory (EEPROM), etc.), and volatile memory 72 (e.g., random-access memory (RAM)). A basic input/output system (BIOS) 74 may be stored in the non-volatile memory 70 and may include the basic routines that help to transfer information between elements within the UE 12. The volatile memory 72 may also include a high-speed RAM, such as static RAM, for caching data. In some implementations, the volatile memory 86 includes a UE data cache 76 operable to store various data metrics and/or measurements associated with the UE 12.

The UE 12 may further include or be coupled to a non-transitory computer-readable storage medium, such as a storage device 78, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 78 and other drives associated with computer-readable media and computer-usable media may provide non-volatile storage of data, data structures, computer-executable instructions, and the like.

A number of modules can be stored in the storage device 78 and in the volatile memory 72, including an operating system and one or more program modules, which may implement the functionality described herein in whole or in part. All or a portion of the examples may be implemented as a computer program product 80 stored on a transitory or non-transitory computer-usable or computer-readable storage medium, such as the storage device 78, which includes complex programming instructions, such as complex computer-readable program code, to cause the processor device(s) 38 to carry out the steps described herein. Thus, the computer-readable program code may comprise software instructions for implementing the functionality of the examples described herein when executed on the processor device(s) 38. The processor device(s) 38, in conjunction with the controller 82 in the volatile memory 72, may serve as a controller, or control system, for the UE 12 that is to implement the functionality described herein.

The UE 12 may also include a number of communication interfaces, such as a communications interface 84, that are suitable for communicating with a network (or devices connected thereto) as appropriate or desired. For instance, the UE 12 may establish a communication link with a wireless communication network 24 via a base station, such as any of the base stations 14-1 – 14-7. The UE 12 may also include the RF chipset 40, which is operable to transmit data to and receive data from the wireless communication network 24. The UE 12 may also include the navigation positioning system 42, which is operable to obtain geolocation data associated with a physical location of the UE 12.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a user equipment (UE) served by a serving base station of a wireless communication network, location data associated with the UE, the wireless communication network comprising a plurality of neighbor base stations adjacent to the serving base station; and
disabling, by the UE based on the location data, neighbor cell measurements for at least one neighbor base station of the plurality of neighbor base stations, the neighbor cell measurements characterizing a signal strength of a communication link between the UE and the at least one neighbor base station.

2. The method of claim 1, wherein the neighbor cell measurements further characterize signal strengths of respective communication links between the UE and respective neighbor base stations of the plurality of neighbor base stations, and wherein disabling the neighbor cell measurements comprises:
disabling, by the UE based on the location data, neighbor cell measurements for one of:
(a) each neighbor base station of the plurality of neighbor base stations; or
(b) a subset of neighbor base stations of the plurality of neighbor base stations, the subset comprising a predetermined number of neighbor base stations.

3. The method of claim 1, wherein obtaining the location data associated with the UE comprises:
for a plurality of sampling periods:
obtaining, by a navigation positioning system of the UE, geolocation data corresponding to a physical location of the UE; and
obtaining, by the UE, serving cell measurements associated with the serving base station, the serving cell measurements characterizing a signal strength of a communication link between the UE and the serving base station.

4. The method of claim 3, wherein disabling the neighbor cell measurements comprises:
based on the geolocation data and the serving cell measurements:
determining, by the UE, that the UE is stationary for the plurality of sampling periods; and
determining, by the UE, a serving-cell location of the UE, the serving-cell location corresponding to a location of the UE within a coverage area of the serving base station; and
in response to determining that the UE is stationary, disabling, by the UE based on the serving-cell location, the neighbor cell measurements for the at least one neighbor base station.

5. The method of claim 4, wherein determining the serving-cell location of the UE comprises:
obtaining, by the UE from a serving sub-station having a coverage area that is within the coverage area of the serving base station, geofencing location data;
determining, by a connection controller of the UE, a location of the coverage area of the serving sub-station relative to the coverage area of the serving base station; and
determining, by the connection controller of the UE, that the physical location of the UE corresponds to a central portion of the coverage area of the serving base station.

6. The method of claim 4, wherein disabling the neighbor cell measurements further comprises:
determining, by the UE, that the serving cell measurements are within a threshold range of signal strength measurements, the threshold range comprising signal strength measurements indicative of stable radio frequency (RF) conditions for the UE at the physical location of the UE; and
in response to determining that the serving cell measurements are within the threshold range, disabling, by the UE, the neighbor cell measurements for the at least one neighbor base station.

7. The method of claim 1, further comprising:
subsequent to disabling the neighbor cell measurements, providing, by the UE to a service provider computing system associated with the wireless communication network, measurement status data and the location data, the measurement status data indicating that the UE disabled the neighbor cell measurements for the at least one neighbor base station.

8. The method of claim 1, further comprising:
subsequent to disabling the neighbor cell measurements, detecting, by the UE, a change in the location data based on updated location data obtained by the UE;
in response to detecting the change in the location data, determining, by the UE, a predicted movement path for the UE based on the updated location data; and
in response to determining the predicted movement path, enabling, by the UE, neighbor cell measurements for each neighbor base station of the plurality of neighbor base stations.

9. The method of claim 8, wherein determining the predicted movement path for the UE comprises:
determining, by the UE based on the location data and the updated location data, a movement direction and a movement speed of the UE; and
determining, by the UE, a predicted location of the UE based on the movement direction and the movement speed.

10. The method of claim 9, wherein enabling the neighbor cell measurements comprises:
determining, by the UE, that the predicted location of the UE is one of:
(a) outside a coverage area of the serving base station; or
(b) at a peripheral portion of the coverage area of the serving base station; and
in response to determining that the predicted location is outside or at a peripheral portion of the coverage area of the serving base station, enabling, by the UE, the neighbor cell measurements for each neighbor base station of the plurality of neighbor base stations.

11. The method of claim 8, further comprising:
obtaining, by the UE, neighbor cell measurements for each neighbor base station of the plurality of neighbor base stations; and
providing, by the UE to a service provider computing system associated with the wireless communication network, measurement status data and the updated location data, the measurement status data indicating that the UE enabled the neighbor cell measurements for each neighbor base station of the plurality of neighbor base stations.

12. A user equipment (UE), comprising:
a radio frequency (RF) device operable to establish a communication link with a serving base station;
a memory; and
a processor device coupled to the memory and operable to:
obtain location data associated with the UE; and
based on the location data, disable neighbor cell measurements for at least one neighbor base station of a plurality of neighbor base stations, the neighbor cell measurements characterizing a signal strength of a communication link between the UE and the at least one neighbor base station.

13. The UE of claim 12, wherein the UE is one of a mobile phone or a mobile tablet device.

14. The UE of claim 12, wherein the neighbor cell measurements further characterize signal strengths of respective communication links between the UE and respective neighbor base stations of the plurality of neighbor base stations, and wherein, to disable the neighbor cell measurements, the processor device is operable to:
disable neighbor cell measurements for one of:
(a) each neighbor base station of the plurality of neighbor base stations; or
(b) a subset of neighbor base stations of the plurality of neighbor base stations, the subset comprising a predetermined number of neighbor base stations.

15. The UE of claim 12, wherein, to obtain the location data associated with the UE, the processor device is operable to:
for a plurality of sampling periods:
obtain geolocation data corresponding to a physical location of the UE; and
obtain serving cell measurements associated with the serving base station, the serving cell measurements characterizing a signal strength of the communication link between the UE and the serving base station.

16. The UE of claim 15, wherein, to disable the neighbor cell measurements, the processor device is operable to:
based on the geolocation data and the serving cell measurements:
determine that the UE is stationary for the plurality of sampling periods; and
determine a serving-cell location of the UE, the serving-cell location corresponding to a location of the UE within a coverage area of the serving base station; and
in response to determining that the UE is stationary, disable, based on the serving-cell location, the neighbor cell measurements for the at least one neighbor base station.

17. The UE of claim 16, wherein, to determine the serving-cell location of the UE, the processor device is operable to:
obtain geofencing location data from a serving sub-station having a coverage area that is within the coverage area of the serving base station;
determine a location of the coverage area of the serving sub-station relative to the coverage area of the serving base station; and
determine that the physical location of the UE corresponds to a central portion of the coverage area of the serving base station.

18. The UE of claim 16, wherein, to disable the neighbor cell measurements, the processor device is further operable to:
determine that the serving cell measurements are within a threshold range of signal strength measurements, the threshold range comprising signal strength measurements indicative of stable radio frequency (RF) conditions for the UE at the physical location of the UE; and
in response to determining that the serving cell measurements are within the threshold range, disable the neighbor cell measurements for the at least one neighbor base station.

19. The UE of claim 12, wherein the processor device is further operable to:
subsequent to disabling the neighbor cell measurements, detect a change in the location data based on updated location data obtained by the UE;
in response to detecting the change in the location data, determine a predicted movement path for the UE based on the updated location data; and
in response to determining the predicted movement path, enable neighbor cell measurements for each neighbor base station of the plurality of neighbor base stations.

20. A non-transitory computer-readable medium that includes executable instructions configured to cause a processor device to:
obtain location data associated with a user equipment (UE), the UE being served by a serving base station of a wireless communication network; and
based on the location data, disable, for the UE, neighbor cell measurements for at least one neighbor base station of a plurality of neighbor base stations, the neighbor cell measurements characterizing a signal strength of a communication link between the UE and the at least one neighbor base station.
